(19) United States
(12) Patent Application Publication
(10) Pub. No.: US 2013/0199101 A1
(43) Pub. Date: Aug. 8, 2013

(54) Barrier-free floor threshold, in particular old building or renovation threshold

(71) Applicant: Claudia Rager-Frey, Kaufbeuren-Oberbeuren (DE)

(72) Inventor: Claudia Rager-Frey, Kaufbeuren-Oberbeuren (DE)

(21) Appl. No.: 13/365,283

(22) Filed: Feb. 3, 2012

(51) Int. Cl. E06B 1/70

(52) U.S. Cl. 49/469

(57) ABSTRACT

The invention refers to a barrier-free floor threshold, in particular old building or renovation threshold that can be put on a finished floor, wherein the floor threshold seals an exterior area of a building against an interior area, or two rooms against each other, while interacting with a window or a door, comprising a basic body, having at least one, preferably two grooves for receiving magnetic seal strips, wherein a first thermal separation is provided on the side of the basic body pointing inwards, and a second thermal separation is provided on the side of the basic body pointing outwards, and wherein a bottom end element is arranged on the side of the basic body facing the floor in order to limit a flume that connects the grooves with an outlet provided on the outside of the basic body.

The invention refers to a barrier-free floor threshold, in particular old building or renovation threshold that can be put on a finished floor, wherein the floor threshold seals an exterior area of a building against an interior area, or two rooms against each other, while interacting with a window or a door.

### BACKGROUND OF THE INVENTION

Floor thresholds of this type are known. However, there is the problem with the so-called renovation or old building thresholds, that because no changes of the floor construction should or could be carried out, there is no floor extension of such a floor threshold. In particular, when, as in the present invention, the rooms should be separated barrier-free, or an interior room should be separated from an exterior area, it is necessary to design these thresholds very flat, as the regulations for nursery homes, hospitals or altogether for barrier-free rooms do not allow anymore an elevation even up to cm. Accordingly, modern thresholds have to be constructed flatter. The problem with such barrier-free floor thresholds is now, on the one hand, to create a passage that allows to be over-rolled by wheelchairs, sick beds, walkers or the like, however, at the same time to guarantee a safe sealed protection, and, most of all, also heat protection in the area between the floor and the door or its bottom edge. An often occurring problem is here, that the thermal separation, in particular of metal thresholds, is extremely complicated. Thus the state of the art does not succeed, because of the flat construction of such a threshold, in realizing a thermal separation according to today's requirements of building owners and architects. Furthermore, the discussed thresholds are often of light metal or metal, what, of course, implicates that these materials have a good heat conductivity, what is just not desired. Accordingly, at least one thermal separation—this is known in the state of the art—should be present in such a floor threshold. This is usually done by adding a material with low heat conductivity to the floor threshold. Another problem is the fact, that in the direction of assembling the floor threshold, if it is of light metal or metal, also a heat conduction occurs, as it were, from the top to the bottom, so that here also a thermal separation has to be performed. The floor thresholds known in the state of the art do not comply with the modern requirements with regard to heat insulation and in particular heat conductivity behavior.

In particular, if magnetic seals form at least a part of the sealing arrangement of the door or the window, there is another problem, namely, that possibly moisture or water, intruding in the grooves in the floor threshold or its basic body, has to be drained. Because of the very flat design or construction of the barrier-free floor threshold, it was not possible so far in the state of the art to develop a suitable drainage concept that guarantees an even flatter construction than the one used so far.

### SHORT ABSTRACT OF THE INVENTION

Referring to this, it is an object of the invention to remove at least one of the before described disadvantages of the state of the art.

The invention refers to the before described state of the art, and suggests for solving this type of problem a barrier-free floor threshold, in particular old building or renovation threshold that can be put on a finished floor, wherein the floor threshold seals an exterior area of a building against an interior area, or two rooms against each other, while interacting with a window or a floor, comprising a basic body having at least one, preferably two grooves for receiving magnetic seal strips, wherein a first thermal separation is provided on the side of the basic body facing inwards, and a second thermal separation is provided on the side of the basic body facing outwards, and wherein a bottom end element is arranged on the side of the basic body facing the floor in order to limit a flume that connects the grooves with an outlet provided on the outside of the basic body.

The barrier-free floor threshold according to the invention solves accordingly at the same time a number of the problems occurring in the state of the art, namely, on the one hand, it improves the thermal separation and thus the insulating qualities of a door or window element altogether, and, on the other hand, it also solves the problem of drainage. At the same time it is considered that the barrier-free floor threshold continues to comply with the regulations of barrier-free function, i.e. that the construction height remains below the allowed height for such barrier-free passages. The floor threshold is constructed here very flat, and is configured, in particular even in the areas where the threshold raises seen from the floor, and in areas where it slopes again to the floor, very flat with a small radius or a small curve. This is also the case with barrier-free passages in countries where the requirements of heat insulation are not so high altogether. Door or window elements for such passages are accordingly characterized in that their dimensions do not correspond with German or European standards, but their thickness is essentially smaller. Of course, also a barrier-free floor threshold has to be configured for this correspondingly as old building or renovation threshold. The problem with floor thresholds of this type is to arrange, in particular two, magnetic seals or the corresponding grooves such one next to the other that even when the dimensions of such a door are small, they work absolutely safely, and in particular guarantee a different attracting of the magnetic strips, when the embodiment has two magnetic strips, such that only the strip is attracted each time above which the corresponding counter magnet is located. The invention solves even this problem, wherein the passages with corresponding curves are also configured such that a wheel chair, a sick bed or a walker or other aids of this type can roll over it without any problems.

Such a less wide floor threshold guarantees also the drainage of the two grooves for the magnetic strips. For that, a flume is provided between the side of the basic body pointing at the floor and a bottom end element. This makes it possible, in particular by a clever connection of the two grooves with the flume, to provide a drainage outwards, and this is also in a very flat barrier-free floor threshold according to the invention. Another problem that has been solved by means of the invention, has already been mentioned, namely that the heat transition from the top to the bottom or from downwards from the floor upwards to the room is interrupted, because the bottom end element of the floor threshold is also of a material with low heat conductivity. This means, the heat transition altogether from the bottom to the top or from the top to the bottom (in built-in position in vertical direction) is interrupted, and also the heat transition from the outside to the inside or from the inside to the outside; here with both thermal separations. The combination of the characteristics of the barrier-free floor threshold according to the invention succeeds in solving all problems, that have not yet been solved in the state of the art, and this for standards complying with Central European, in particular German requirements, as well for the ones that do not have so high requirements. Accordingly, the floor threshold according to the invention can also be employed in countries where such high heat insulation may not be necessary. The invention provides a suitable solution for both target groups and can be applied universally to both embodiments.

As already mentioned, a flume is connected with the preferably two grooves, in which the magnetic seal strips are arranged. According to the invention, the flume is connected with both grooves, so that leaking water is conducted each time directly in the flume. Another advantage has to be mentioned here, namely that the outlet openings can be arranged in particular staggered to the inner webs in the basic body. This makes it possible, for example when the wind is strong, to prevent the moisture from being pushed back, and to prevent at the same time, that, during driving rain and strong winds, water intrudes in these openings and thus in the flume.

An advantageous development of the invention is characterized in that both thermal separations can be inserted, in particular be clipped in recesses of the basic body. These recesses in the basic body are arranged preferably each time next to the grooves for the magnetic seal strips, once to the outside and once to the inside. Thus, a basic body can be manufactured very economically, for example in the extrusion process for light metal profiles. In particular the effort for arranging or inserting the thermal separations in the basic body is thus reduced considerably, as just the recesses in the basic body are arranged directly next to the grooves. It is an advantage, as already mentioned before, that the thermal separations are made of material differing from the basic body, in particular of synthetic material. The result is an excellent insulation quality or thermal separation. By arranging two thermal separations in the heat transition course from the outside to the inside, it becomes possible to improve clearly the insulation qualities of a floor threshold, manufactured in particular from light metal or aluminum. Additionally, the bottom end element is also made of different material. Preferably, also synthetic material is used here. This also interrupts the heat transition from the outside to the inside and vice versa, as well as seen from the floor to the top, or vice versa. Accordingly, a completely perfected floor threshold is the result altogether, that complies with all heat-related requirements. However, this floor threshold can also be used at the same time as barrier-free floor threshold, in particular in old buildings or as renovation threshold, and this is also in so-called barrier-free living spaces or institutions and buildings. The basic body is formed, as already mentioned a couple of times, of light metal, in particular aluminum, and can therefore be obtained very economically in the extrusion process.

The threshold according to the invention is characterized furthermore in that a limb pointing outwards and a limb of the basic body pointing inwards is guided to the floor with a constant curve. This constant curve has already been mentioned at the beginning and serves for producing the barrier-free passage as favorably as possible. This means, neither edges nor shoulders occur by the floor threshold, but by means of this limb it becomes possible, starting slightly rising at the level of the floor, as it were, to overcome the floor threshold, and then the drop slightly again on the other side of the floor threshold. This prevents appropriate handicapped vehicles or equipment from being hooked or jammed.

An advantageous modification of the invention is characterized in that at the connection of the limb with the basic body a predetermined curving point is provided to adapt the limb to the level of the interior floor, for example to bring it in a position that has been adapted to the floor level of the interior floor. Of course, in the same way also on the other side of the connection of the other limb to the outside an appropriate predetermined curving point can be provided, for example, to adapt this limb to the level of the exterior floor. Thus, the floor threshold can also be employed in buildings the rooms of which have different floor levels. Adapting is very easy with the floor threshold according to the invention. For that it has, as already mentioned, at least on one of the sides of the floor threshold a suitable limb with a predetermined curving point in order to bring this limb to the level of the respective floor.

For a further improvement of curving the limb, on the side of the respective predetermined curving point facing the floor or opposite a recess is arranged. This recess serves for an even easier bending of the limb or limbs. However, it also serves for preventing a fracture from occurring there. The particular way of the design of the recess, for example as rounding, seen in section, prevents this.

As already described in the beginning, a development of the invention is characterized in that the end profile facing downwards, that is also designed to be slid on the basic body, is formed of a material differing from the basic body, in particular a material with low heat conductivity, for example synthetic material. The respective advantages have already been described in the beginning.

The floor threshold according to the invention is also characterized in that the magnetic seal strips interact, when the window or door is closed, with counter magnets arranged there correspondingly on the side pointing to the floor for sealing a gap between the floor threshold and under edge of the door. The threshold according to the invention is characterized in particular in that two magnetic strips are arranged next to each other (seen from the outside to the inside) in the basic body. For that, of course, also correspondingly to this the respective counter magnets are arranged at the bottom limb of the door or the window, that are exactly opposite, this means, on the side of the door or window pointing to the floor.

It has proved to be an advantage when the counter magnets are attached to a beam attached to the window or the door or imbedded in the window or the door. Through this the counter magnets can be attached to the beam correspondingly before, and in a single manner exactly fitting be adapted to the window or the door at the underside. It is another advantage of the invention here that the floor threshold does not only have these two magnetic seal strips in interaction with the counter magnets as seal elements, but it is also possible with the floor threshold according to the invention to provide further seals, such as, for example, a suitable floor seal at a rain guard in order to improve the sealing effect altogether. Furthermore, it is, of course, also possible to arranged at the inside of the door also a sealing profile pointing at the floor, for example a hollow profile, in order to get a further improvement of the sealing effect also here. Thus the floor thresholds as old building thresholds have almost the same quality regarding the sealing effect as new building thresholds that can be imbedded in the floor.

It is another advantage when the counter magnets each time are arranged at or attached to single beams, and the single beam(s) have/has at the side pointing at the underside of the window or door a peg by means of which it/they can be attached in the window or door. These pegs then are put in, for example pre-bored, bore holes in the door or in the window at the underside, and fastened similar to dowels.

The floor threshold according to the invention is furthermore characterized in that the counter magnet(s) itself/themselves have/has a peg formed at the side pointing at the window or door, that can be put in the underside of the window or door, in particular can be fastened there. This is performed, for example, by pushing-in or driving-in these counter magnets.

The counter magnet according to the invention has a concave surface on the side pointing at the floor threshold or the magnetic strip. This concavely configured, magnetized surface is characterized here as so-called north pole magnetized surface with a preferably three-pole design with the sequence south pole, north pole, south pole. Advantageously the peg provided at the counter magnets or at single beams has a ribbing or a thread in order to get a dowel-like effect.

The invention is furthermore characterized by another embodiment, that is characterized in that the counter magnet(s) is/are configured as strips and in one piece, is/are able to interact with both magnetic seal strips. This means it is possible with a single counter magnet to cover the width of both magnetic seal strips in order to get thus the desired magnetic effect, when magnetic seal strips and counter magnet are arranged exactly opposite. The polarity is designed here in the one-piece counter magnet such that both magnetic seal strips are attracted just when they are opposite the counter magnet.

As already mentioned, one embodiment of the invention is characterized in that the respective limb is configured outwards and inwards, respectively, that can be adapted to the floor by bending. In a preferred development it is now provided, that one of the limbs is longer than the other limb in order to compensate a height difference of several millimeters, for example between 5 to 10 mm, in particular up to 30 mm, between the floor outside and the floor inside by bending. This can be provided, of course, also when the height difference is from the inside to the outside: the limb that is each time on the side where the floor is lower, is longer in order to just compensate clearly favorably the height difference.

The invention is also characterized in that a connecting profile is provided as height compensation profile that can be attached at the underside of the basic body at the side facing outwards or the side facing inwards, and the connecting profile receives or carries an additional limb for further height compensation between outside and inside. This serves for overcoming certain steps, for example, when the floor level of an outside terrace is lower then the interior area. The same goes, of course, for the exterior area that may be built higher or lies on a higher level than the interior area. The height compensation profile is then arranged on the inside of the floor threshold in order to achieve this height compensation. The connecting profile is configured here such that it can be attached, for example by means of screws, at the underside of the floor threshold, that means the side pointing at the floor. The additional limb is provided such that, on the one hand, an almost step-less attachment can be carried out at the floor threshold, on the other hand, however, leaking of moisture or liquid from the flume is not prevented.

Advantageously, the additional limb has for this an angular deflection that can be slid in a seating of the connecting profile, wherein an at least positive, however, preferably a positive and non-positive connection is formed. For further height compensation functions at the additional limb a predetermined curving groove is provided with a shaping arranged preferably opposite, correspondingly. Thus it is possible, analogous to the design with the predetermined curving point at the floor threshold itself, to compensate corresponding height differences. Of course, it is also provided according to the invention, that, for example, facing outwards a connecting profile with an appropriate additional limb is provided, while at the inside a usual limb of the floor threshold is provided that can also be adapted to the level of the floor. Of course, the invention comprises also an arrangement vice versa.

A convenient modification of the invention is characterized in that the seating of the connecting profile is, seen in section, circular or designed as roller pan for receiving a correspondingly configured roller of the additional limb or of an intermediate part. This is a very clever design of the invention, as it is possible by means of this, without bending the material, for example, at a predetermined curving point, to guarantee a height compensation function, and this is in a height that could still lead to a deformation, for example, when forming the predetermined curving point, what leads to an affection of the shape of the material that it cannot withstand anymore permanent stress. Exactly for this case it is provided that the additional limb is arranged, for example, in an intermediate part that is equipped just with the before-described pan-shaped form, on the one hand, and, on the other hand, with a corresponding slid-in groove for the additional limb.

A development of the before-described embodiment is characterized in that an end element can be arranged at the connecting profile in a fastening groove provided there, in order to determine swiveling the additional limb or the intermediate part arranged there. As it is, this end piece forms the top limit of the roller pan, when it is then inserted in the groove. Swiveling is then easily possible. If the desired angle has been set, by means of the connecting piece then the intermediate part can be determined.

Furthermore, it is an advantage, if at the side of the connecting profile pointing at the floor a height adapting device is provided, that can be determined in a connecting groove formed at the connecting profile. This serves for preventing the connecting profile from tilting, when the height difference is such that the connecting piece cannot be supported with certain material. In order to avoid here a subsequent sinking or sliding or forming of fractures, the height adapting device is very advantageous, as it can be set to a once chosen height, and can then be determined. For this, for example, in the bottom area there is a plate-like support element that is supported on the floor, that engages by means of an adjusting screw at the top part of the height adjusting device. If the thread is set to the desired level, by means of one or two counter nuts the height adjusting device can be determined. As already mentioned, the configuration with an intermediate part at the connecting profile is configured such, that, for example, at the intermediate part carrying the roller, at the side facing outwards, a slid-in groove is formed in order to receive the additional limb. Now it is possible to add the additional limb of any length. For example, if the material of the limb for the height compensation function is too long, it is possible without any problems to cut off a piece of the additional limb. This is usually performed with standard working means, and does not have the disadvantage of a weakening of the material.

The invention is also characterized in that a sealing can be arranged, in particular by means of a coated metal at the underside of the basic body. This sealing serves for sealing the exterior area, for example outside a building, such as a balcony, an outdoor terrace or the like, against the interior area. During construction often the area is neglected where the floor thresholds are arranged. The sealing is provided for sealing this area safely and reliably. This avoids that later defective constructions have to be removed because exactly this sealing has been forgotten. The sealing can be fastened here advantageously by welding, cold or heat adhesion at the basic body. It is advantageously fastened here such that it is arranged at the floor threshold before this is finally fixed or attached to the floor. The sealing sheeting of the sealing is here designed in such a way that it can be guided, for example, so far that it reaches beyond the additional limb of the connecting profile. However, at least it should be guided so far, that it reaches, for example, still beyond the area of the height adjustment device, in order to seal this area safely. Further outwards then, of course, as usual, another sealing sheeting can be connected to or glued over it.

Another aspect of the invention refers to a height compensation profile, in particular for a floor threshold as described before. This height compensation profile can be provided generally at floor thresholds, on the exterior side as well as on the interior side of this floor threshold. It consists at least of one connecting profile, one additional limb as well as one height adjustment device. However, this height adjustment device is also optional. The height compensation profile can also be employed without this height adjustment device, for example when the height differences to be compensated are not so large. The height compensation profile has, as already mentioned, an additional limb that can be attached to an intermediate part, according to a modification of the invention, in particular be slid in a slid-in groove. This intermediate part can be provided here, as already described further above, with an angular deflection in order to insert it in a groove, to define the additional limb. However, another embodiment comprises also an embodiment of the intermediate part as roller pan, the roller pan having a seating in which a roller of the additional limb can be inserted, in particular swiveling. The advantages of such a configuration have already been described for the floor threshold and the corresponding embodiment. They go also here for the single profile in the same way.

The invention also refers to a system-opening or system-closing element, such as, for example, a window or a door with a floor threshold as described before, or with a height compensating profile as also described before. This system-opening or system-closing element as window or door is equipped such that the space between the bottom element part, i.e. for example the door wing, and the floor threshold is sealed securely. According to the invention, for example two magnetic sealing strips are provided for that, interacting with counter magnets at the underside of the door or the window. Advantageously, however, according to the invention even other sealing elements can be provided, such as, for example, a profile seal in a rain guard that is, of course, arranged advantageously at the outside of the window or the door. Furthermore it is possible to provide also at the inside of the system-opening or system-closing element another profile seal, additionally sealing also the interior area. This prevents safely altogether, first, moisture from intruding and, secondly, cold from intruding and heat from leaking by means of such a sealing arrangement at the door or the window very reliably and over a long period of time.

### BRIEF DESCRIPTION OF THE DIFFERENT VIEWS OF THE DRAWINGS

In the drawing the invention is shown in particular schematically in an example. In the figures:

FIG. 1 e floor threshold according to the invention,

FIG. 2 a modification of the floor threshold shown in FIG. 1,

FIGS. 3a and 3b another embodiment of the floor threshold according to the invention,

FIG. 4 a design of the floor threshold according to FIG. 1 with different counter magnets,

FIG. 5 another embodiment of the floor threshold according to the invention with one-piece counter magnet,

FIGS. 6a to 7 next embodiments of a floor threshold according to the invention with deflecting interior limb with different length,

FIG. 8a a floor threshold with connecting profile as height compensation profile,

FIG. 8b a first embodiment of a height compensation profile according to the invention,

FIGS. 9a and 9b another modification of a height compensation profile according to the invention.

### DETAILED DESCRIPTION OF THE PREFERRED EMBODIMENT

In the figures identical or corresponding elements each are indicated by the same reference numbers, and therefore are, if not useful, not described anew.

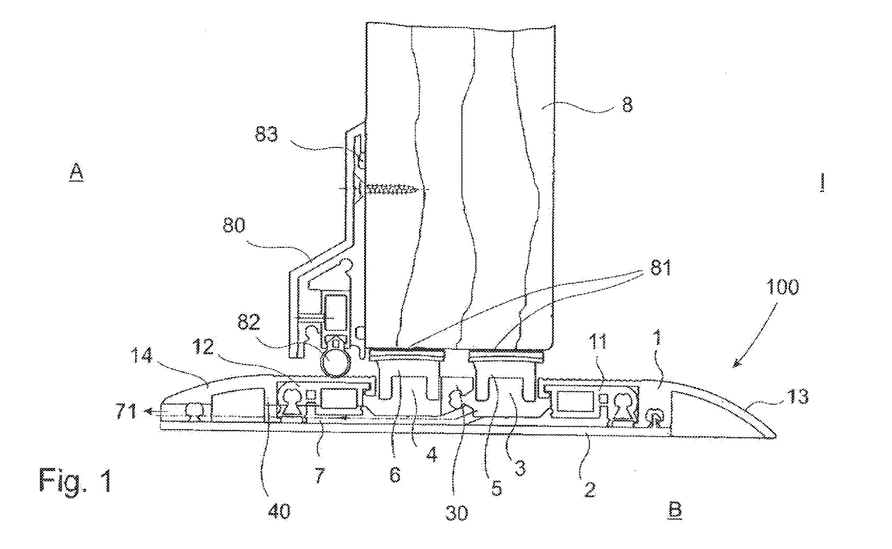

FIG. 1 shows a floor threshold 100 according to the invention. The floor threshold 100 consists here of a basic body 1. In the basic body 1 a first thermal separation 11 and a second thermal separation 12 each are arranged next to grooves 3, 4 for magnetic seal strips 5, 6. The grooves 3, 4 are connected to a flume 7 extending at the underside of the basic body 1. The outlet 71 is arranged at the side of the basic body 1 pointing outwards A. On the side facing the floor B a bottom end element 2 is provided. This bottom end element 2 is formed, just like the first and the second thermal separation 11, 12, of a material differing from the basic body 1. Preferably synthetic material is used. In order to guarantee sufficient stability of the mentioned construction elements, it is, of course, possible, to use accordingly fiber-reinforced synthetic material. However, the invention is not restricted to this. On the side of the basic body 1 facing inwards I an inner limb 13 is provided. On the side facing outwards A an outer limb 14 is arranged. The floor threshold 100, indicated schematically by an arrow, interacts, when working according to its purpose, with a door 8 or a window. The drawing shows in side view the door wing. At the underside of the door wing the counter magnets 81 are arranged correspondingly with the magnetic strips 5, 6 so that, when the door 8 is closed, the magnetic strips 5, 6 are drawn upwards. Both grooves 3, 4 are connected, as already mentioned, with the flume 7. This flume 7 is here designed so cleverly, that it extends above the end element 2 and is thus guided across the floor that it is guided outwards A without any problems. In particular outlet openings of the outlet 71, that are not indicated in detail, are provided staggered to inner webs 30, 40. This configuration prevents, that, for example through heavy rain or driving rain, moisture is pushed inwards. The outward outlet A, however, is not affected. On the door 8, on the side facing outwards A a rain guard 80 is provided. The rain guard 80 carries here an additional seal 82 configured as hollow profile. The rain guard 80 is fastened to the door by means of a screw. Preferably another seal is provided in the upper area of the rain guard 80 in order to prevent moisture from intruding even there. This may be, for example, a usual silicone joint 83, that is provided before attaching the rain guard. As the rain guard 80 is configured of two parts, for example the screw can be arranged covered, so that it is not affected later on by moisture and no ugly rust spots occur.

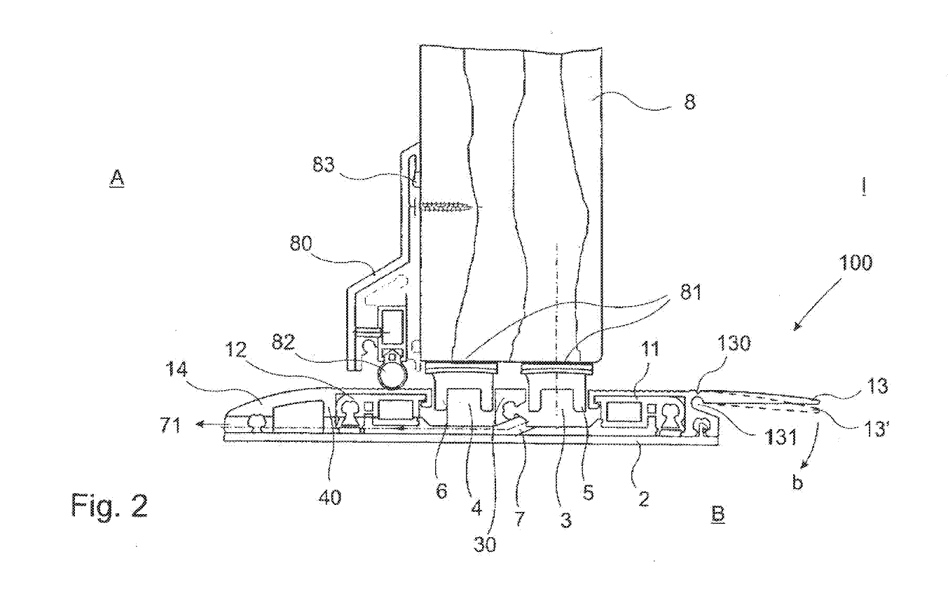

FIG. 2 shows a modification of the floor threshold 100 shown in FIG. 1. The same reference numbers as in FIG. 1 have been used. The reference numbers are conveniently also used in the other figures, so that differences are described again only if necessary. In contrast to the modification of the invention shown in FIG. 1, the floor threshold 100 is provided with the inner limb 13 that has here at the joining point of the limb 13 with the basic body 1 a predetermined curving point 130. By means of this the inner limb 13 can be bent in a position 13′. This is performed in direction b, that means pointing to the floor B, if, for example, the interior floor is lower than the exterior floor B. In order to make bending even easier, on the side opposite the predetermined curving point 130 a recess 131 is arranged. This is, as it can be seen, rounded, so that bending does not cause such a material modification that a fracture can occur. Furthermore, of course, this recess 131 makes bending in direction b easier.

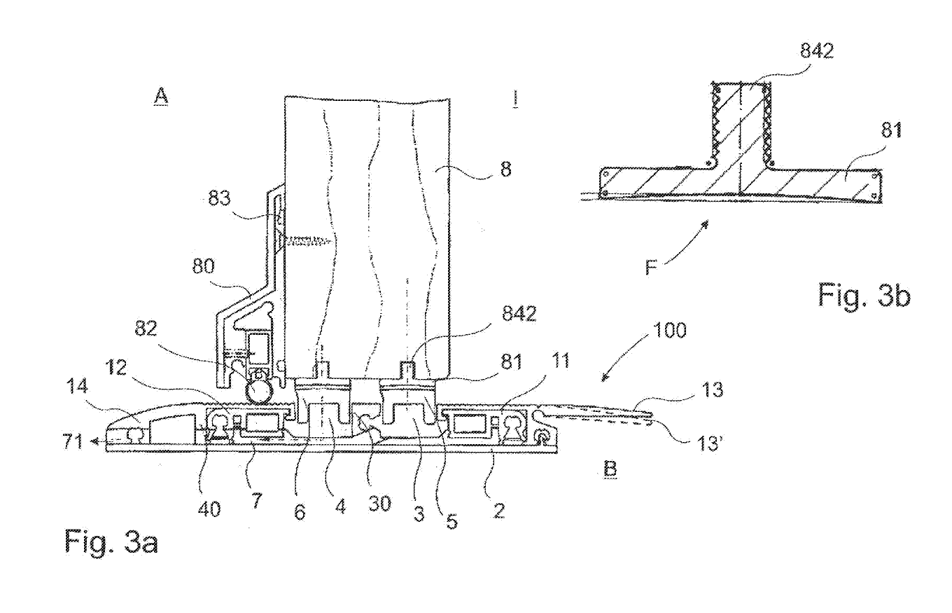

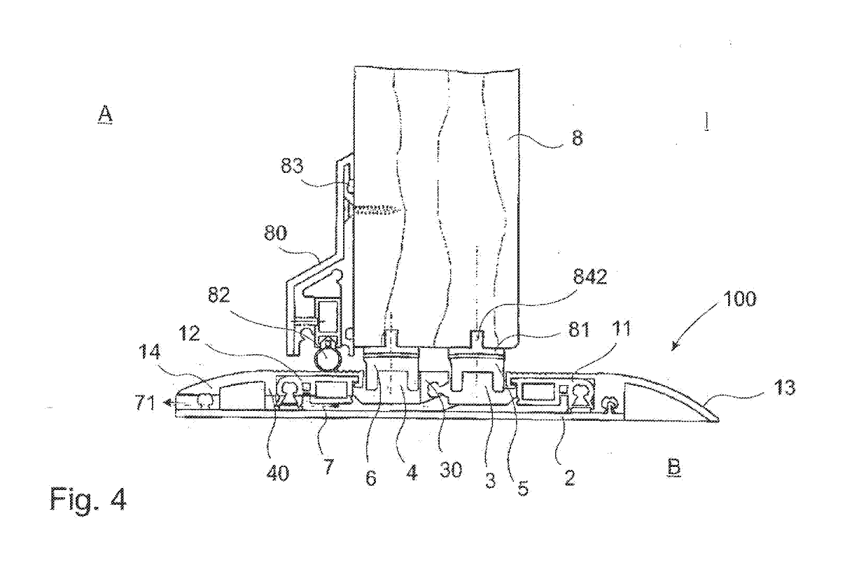

FIGS. 3a, 3b and 4 show another modification of the floor threshold according to FIGS. 1 and 2, however, here with different counter magnets 81. As it can be seen, the counter magnets 81 have an attached peg 842 here. This serves for fastening the counter magnet 81 in the wing of the door 8 or the window. Only a corresponding bore hole has to be bored in the door 8 for sliding in the counter magnet 81 with the peg 842. The principle works here in that way, that the bore hole is executed slightly smaller than the outer diameter of the peg 842, so that the peg 842 works like a dowel. For that the peg 842 has advantageously a ribbing or a thread to accomplish this dowel-like effect. FIG. 3b shows an enlargement of an embodiment of the counter magnet 81. It can be seen here that this counter magnet 81 has on the side facing the floor threshold or the magnetic strips 5, 6 a surface F. This surface F is designed advantageously concavely. Furthermore, this north pole-magnetized surface F is provided with a preferably three-pole configuration, so that a sequence, for example south pole, north pole, south pole is provided. The result is, that the magnetic seal strips are attracted safely, when the door is closed. Furthermore, this effects an extremely favorable sealing effect, as, because of the concave design of the surface F, wind, moisture and/or heat is prevented from intruding. FIG. 3a differs from FIG. 4 only by the fact that the limb 13 facing inwards I is provided with a corresponding predetermined curving point 130 in order to bring this limb in a lower position 13′, indicated by a dashed line. In FIG. 4 this limb is configured fixed, this means it cannot be changed.

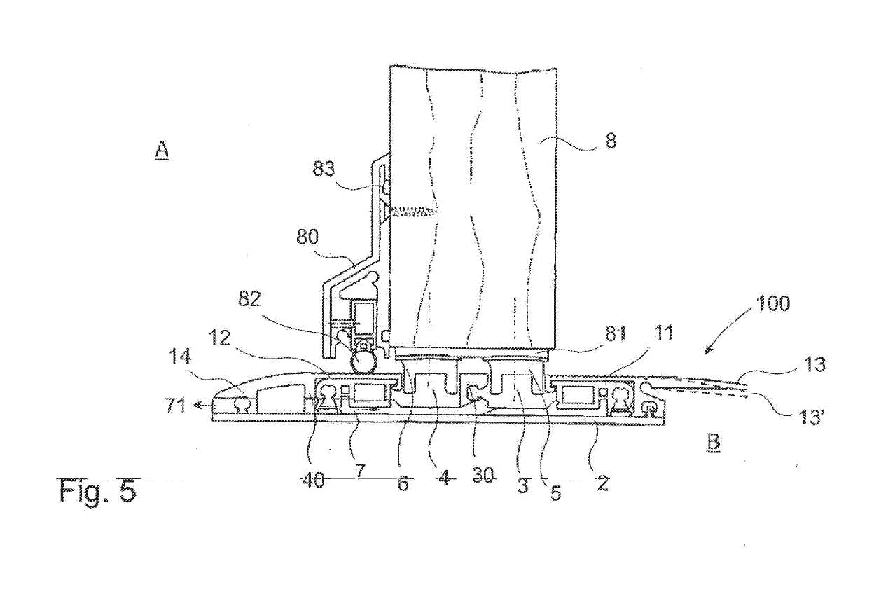

FIG. 5 shows another embodiment of the floor threshold 100. Here only the counter magnet 81 is designed in one piece. This means, that the counter magnet 81 is configured such, that its width is located exactly above the magnetic seal strips 5, 6 when the door is closed, to attract then both magnets each time. The polarity of the counter magnet 81 is such that it acts just like single counter magnets, accordingly here, for example, a polarity south pole, north pole, south pole and south pole, north pole, south pole could be provided. Otherwise, the embodiment shown in FIG. 5 is essentially identical with the modification shown in FIG. 3a.

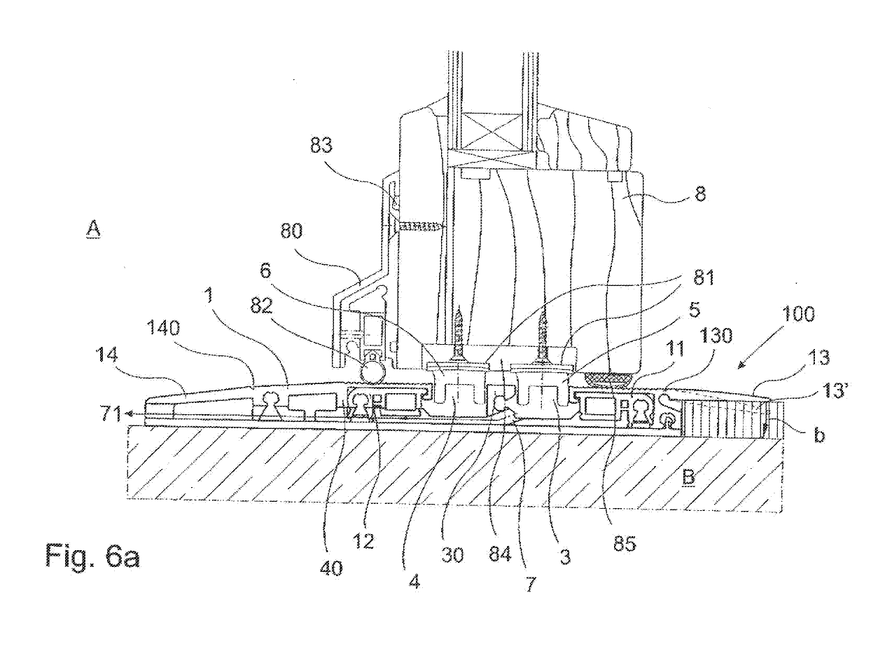

FIGS. 6a, 6b and 7 show next embodiments of a floor threshold 100 according to the invention with bending inner limb of different length. Here again the same reference numbers as in the previous modifications have been used. However, as it can be seen here, a floor threshold 100 is shown the width of which covers (seen in section) larger dimensions than the before presented modifications. Apart from that, here again the same reference numbers as before have been used. In contrast to the modifications presented so far, the door 8 has a recess on the underside in which a beam 84 is imbedded. This beam 84 can be fastened, for example, by means of fastening screws to the door 8. This beam 84 carries the counter magnets 81. Furthermore, it can be seen that on the side pointing inwards I another seal 85 is provided in order to further increase the sealing effect altogether. At the exterior limb 14 or its connection with the basic body a predetermined curving point 140 is provided in order also to carry out a compensation here, if necessary. All other reference numbers have already been presented and are here also used in the same way. FIGS. 6a, 6b and 7 differ only in that the limb 13 of the basic body 1 pointing inwards I has a different length, so that it can be bent in different depths, as indicated by the dashed position 13′ of the limb 13. Here, for example, the limb 13 pointing inwards is clearly longer than the outwards A pointing limb 14. Thus it can be bent essentially more so that height differences of several millimeters, for example 5 to 10 mm, in particular up to 30 mm, can be compensated.

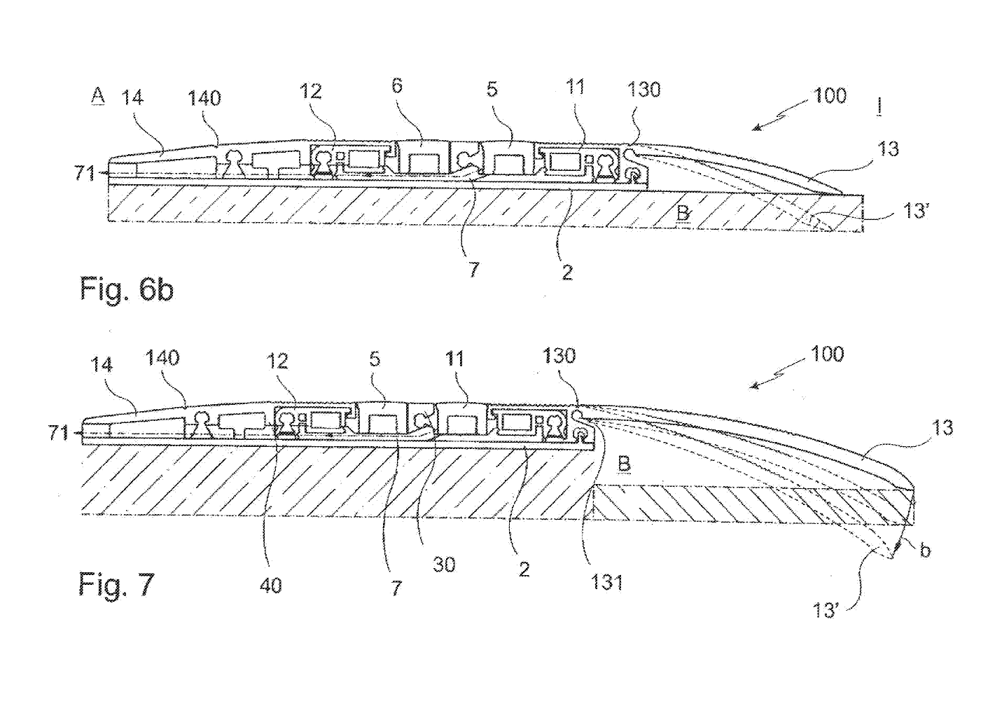

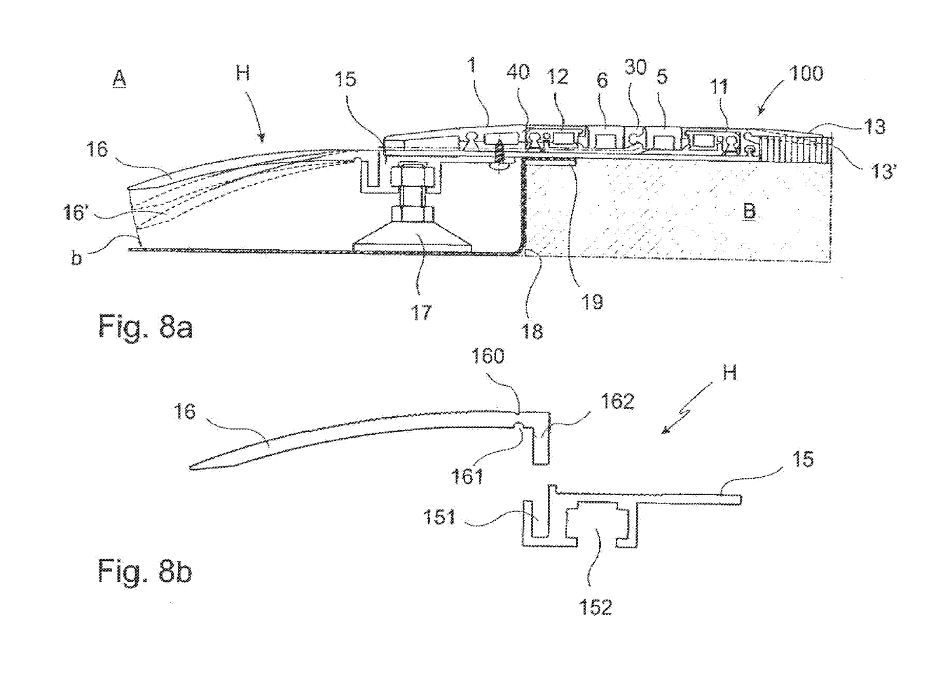

FIG. 8a shows a floor threshold 100 with a connecting profile 15 as height compensation profile H. This connecting profile 15 is here fastened to the underside of the floor threshold 100. This is carried by means of the usual fastening means, such as for example at least one screw. The connecting profile 15 has here an additional limb 16 provided on the side facing outwards A. This additional limb 16 can again be curved in a position indicated by 16′ in the direction b. In order to be able to compensate certain measurement tolerances, a height adjustment device 17 is provided that can be defined in a connecting groove 152. As it can be seen, the height adjustment profile can be defined, for example, by means of suitable counter nuts. The height compensation profile H consists of two pieces, namely the connecting profile 15 and the additional limb 16, as it is shown in FIG. 8b. In order to make curving easier, again a predetermined curving groove 160 with a corresponding, opposite recess 161 is provided. The additional limb 16 can be slid in a seating 151, for example with an angular deflection 162. Thus, mounting can be performed such that, for example, first the connecting profile 15 is fastened to the floor threshold 100, and then, when the floor threshold 100 is also fixed to the floor B, the additional limb 16 is added. A design of this kind is an advantage, in particular, when larger height differences between outside A and inside I have to be overcome. Here, the floor threshold 100 with the connecting profile 15 or the height compensation profile H configured thus helps creating a passage that can be overcome essentially also by handicapped vehicles or handicapped equipment. In particular when renovating old buildings, such a floor threshold can be employed very favorably as often just there such height differences are found. Compensating the floors by filling can be carried out, as a rule, only with great effort, and has to be carried out, in particular, with suitable seals what regularly leads to problems. The height compensation profile H can remove these problems. This height compensation profile H can be arranged here, as shown, on the side of the floor threshold pointing outwards A as well as in a not shown embodiment also on the side facing inwards I. FIG. 8a also shows, that the inner limb 13 is designed here curving in the position 13′. A seal 18 is fastened by means of a coated metal 19 at the underside of the floor threshold 100 or its basic body 1.

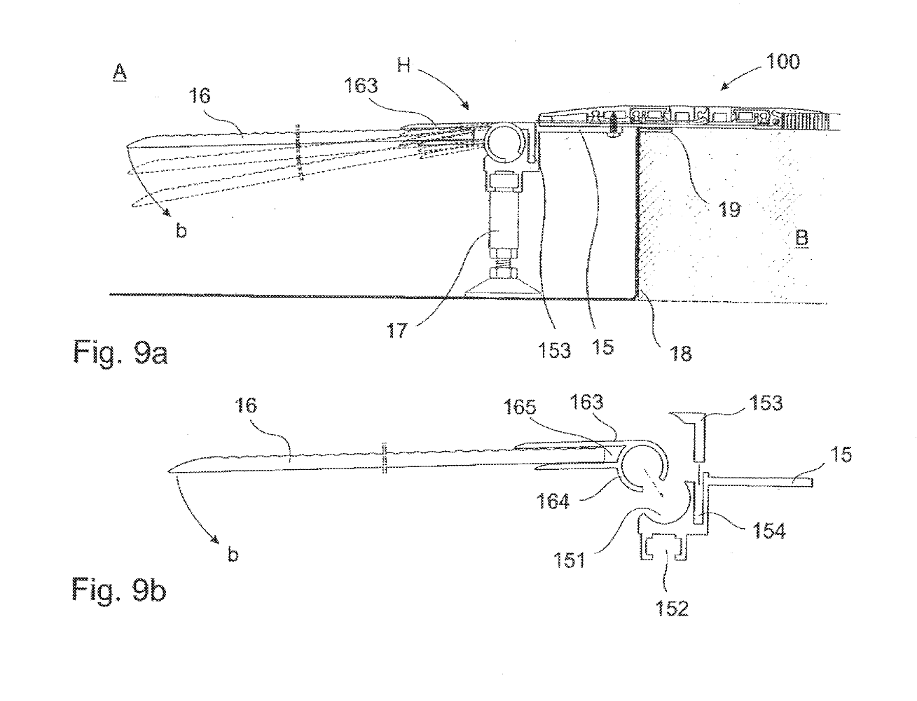

In FIGS. 9a and 9b another modification of a height compensation profile H is shown. This profile is also characterized by a connecting profile 15 that has here, however, a seating 151, that is, seen in section, configured circularly or as roller pan in order to receive a correspondingly designed roller 164 of the additional limb 16 or of an intermediate piece 163. FIG. 9b shows an enlargement and a single representation of the height compensation profile H. It becomes also clear here, that the intermediate piece 163 has a slid-in groove 165. This again can receive an additional limb 16 designed at one end correspondingly to the slid-in groove 165. This additional limb 16 can be supplied in a width that is sufficient for overcoming different widths. In order to make an adjustment on site, it is easily possible to cut off a piece of the additional limb 16.

This is carried out with usual working tools, such as, for example, a suitably configured mortising machine or saw. If the roller 164 of the intermediate piece 163 is imbedded in the seating 151, for determining the intermediate piece 163 in the desired position, an end element 153 is put in a fastening groove 154 provided for that. The roller pan is thus closed, as it were, and a sliding out of the intermediate piece 163 is not possible anymore.

Although the invention has been described in terms of specific embodiments that are set forth to the greatest possible extent, it is pointed out, that this serves only for illustration, and that the invention is not necessarily limited thereto, as alternative embodiments and methods become clear to those skilled in the art in view of the disclosure. Accordingly, changes can be considered which can be made without departing from the contents of the described invention.

1. Barrier-free floor threshold, in particular old building or renovation threshold, that can be put on a finished floor, wherein the floor threshold seals an exterior area of a building against an interior area, or two rooms against each other, while interacting with a window or a door, comprising a basic body having at least one, preferably two, grooves for receiving magnetic seal strips, wherein a first thermal separation is provided on the side of the basic body facing inwards, and a second thermal separation is provided on the side of the basic body facing outwards, and wherein a bottom end element is arranged on the side of the basic body pointing at the floor in order to limit an outlet connecting the grooves with a flume provided at the outside of the basic body.

2. Floor threshold according to claim 1, wherein the flume is connected to both grooves such that leaking water is conducted each time directly in the flume, the outlet and its outlet openings, respectively, being arranged in particular staggered to inner webs in the basic body.

3. Floor threshold according to claim 1, wherein both thermal separations can be slid in, in particular clipped in recesses of the basic body arranged preferably each time next to the grooves, and/or the thermal separations are formed of material differing from the basic body, in particular synthetic material.

4. Floor threshold according to claim 1, wherein the basic body is formed of light metal, in particular aluminum.

5. Floor threshold according to claim 1, wherein a limb pointing outwards and a limb of the basic body pointing inwards are provided and guided with constant curve to the floor, and/or at the connection of the limb with the basic body a predetermined curving point is provided to adjust the limb to the level of the inner floor, for example, to bring it in a corresponding position.

6. Floor threshold according to claim 1, wherein a predetermined curving point is provided at the connection of the limb with the basic body, and preferably a recess is arranged on the side of the predetermined curving point pointing to the floor.

7. Floor threshold according to claim 1, wherein the end element is formed of a material differing from the basic body, in particular a material with little heat conductivity, such as, for example, synthetic material.

8. Floor threshold according to claim 1, wherein, when the window or door is closed, the magnetic seal strips interact with counter magnets arranged there on the side pointing to the floor correspondingly for sealing a gap between floor threshold and the bottom edge of the door, and/or the counter magnets are fastened to a beam attached to the window or the door or embedded in the window or the door.

9. Floor threshold according to claim 1, wherein counter magnets are provided, and the counter magnets are each time arranged at or attached to a single beam, and the single beam has a peg at the side pointing to the underside of the window or the door, wherein by means of the peg it can be attached in the window or the door, and/or the counter magnet(s) itself/themselves has/have a peg formed at the side pointing to the window or the door, the peg being able to be put in the underside of the window or the door, in particular to be fastened there, wherein the peg has preferably a ribbing or a thread to get a dowel-like effect.

10. Floor threshold according to claim 1, wherein counter magnets are provided, and the counter magnet(s) has/have at the side pointing at the threshold or the magnetic strip a surface that is concave, and/or the counter magnet(s) has/have a surface magnetized north pole, wherein the north pole magnetized surface has a preferably three-pole configuration with the sequence south pole, north pole, south pole.

11. Floor threshold according to claim 1, wherein one or more counter magnet(s) is/are provided, and the counter magnet(s) is/are configured as strips and in one piece, and interact(s) with both magnetic seal strips.

12. Floor threshold according to claim 1, wherein at the side of the basic body facing outwards or inwards limbs are arranged, and the inner limb is longer than the outer limb, in order to compensate a height difference between the floor outside and the floor inside of several millimeters, for example 5 to 10 mm, in particular of up to 30 mm, by bending.

13. Floor threshold according to claim 1, wherein a connecting profile is provided as height compensation profile that can be attached at the underside of the basic body at the side pointing outwards and/or inwards, and the connecting profile receives or carries an additional limb for further height compensation between the outside and the inside, wherein the additional limb has preferably an angular deflection that can be slid in a seating of the connecting profile, wherein in particular an at least positive, however preferably a positive and non-positive, connection is formed, and/or at the additional limb a predetermined curving groove is provided with a corresponding shaping, arranged preferably opposite.

14. Floor threshold according to claim 1, wherein an additional limb with a seating at a connecting profile is provided, and the seating is, seen in cross section, circular or designed as roller pan in order to receive a correspondingly designed roller of the additional limb or of an intermediate element.

15. Floor threshold according to claim 1, wherein an end piece can be arranged at a connecting profile in a fastening groove provided at it for swiveling defining an additional limb or an intermediate element arranged at it, and/or at the side of the connecting profile pointing at the floor a height adjustment device is provided that can be defined in a connecting groove formed at the connecting profile.

16. Floor threshold according to claim 1, wherein an intermediate element is provided, and a push-in groove is formed at the side of the intermediate element facing outwards for receiving an additional limb, and/or a sealing can be arranged at it, in particular by means of a coated metal at the underside of the basic body, and/or the seal can be attached by welding, cold or heat adhesion to the basic body.

17. Height compensation profile, in particular for a barrier-free floor threshold, in particular old building or renovation threshold, that can be put on a finished floor, wherein the floor threshold seals an exterior area of a building against an interior area, or two rooms against each other, while interacting with a window or a door, comprising a basic body having at least one, preferably two grooves for receiving magnetic seal strips, wherein a first thermal separation is provided on the side of the basic body facing inwards, and a second thermal separation is provided on the side of the basic body facing outwards, and wherein a bottom end element is arranged on the side of the basic body pointing at the floor for limiting a flume that connects the grooves with an outlet provided at the outside of the basic body, comprising at least one connecting profile, one additional limb as well as preferably one height adjustment device.

18. Height compensation profile according to claim 17, wherein an additional limb can be fastened to an intermediate element, in particular be slid in a push-in groove, and/or the intermediate element has a seating designed as roller pan in which a roller of the additional limb can be put in, in particular swiveling.

19. System-closing or system-opening element, such as for example a window or a door with a barrier-free floor threshold, in particular old building or renovation threshold, that can be put on a finished floor, wherein the floor threshold seals an exterior area of a building against an interior area or two rooms against each other, while interacting with a window or a door, comprising a basic body having at least one, preferably two grooves for receiving magnetic seal strips, wherein a first thermal separation is provided on the side of the basic body facing inwards and a second thermal separation is provided on the side of the basic body facing outwards, and wherein a bottom end element is arranged on the side of the basic body pointing at the floor in order to limit an outlet that connects the grooves with a flume provided on the outside of the basic body, or a height compensation profile comprising at least one connecting profile, one additional limb and preferably one height adjustment device.
